(19) United States
(12) Patent Application Publication
(10) Pub. No.: US 2016/0139362 A1
(43) Pub. Date: May 19, 2016

(54) Imaging Lens And Imaging Device

(71) Applicant: KONICA MINOLTA, INC., Tokyo (JP)

(72) Inventor: Takashi KAWASAKI, Suginami-ku, Tokyo (JP)

(73) Assignee: KONICA MINOLTA INC., Chiyoda-ku (JP)

(21) Appl. No.: 14/900,022

(22) PCT Filed: Jun. 3, 2014
(86) PCT No.: PCT/JP2014/064683

§ 371 Date: Dec. 18, 2015

(30) Foreign Application Priority Data
Jun. 20, 2013 (JP) 2013-129311

(51) Int. Cl. G02B 13/00; G02B 27/00; G02B 9/34

(52) U.S. Cl. CPC G02B 13/004; G02B 9/34; G02B 27/0025

(57) ABSTRACT

Imaging lens including four lenses capable of widening an angle of view and reducing height compared to a conventional imaging lens while reducing cost and securing optical performance. The lens includes a first lens, a second lens, a third lens, and a fourth lens in order from an object side. The first lens and the second lens have negative refractive power. An object-side surface of the first lens has an aspherical shape. Moreover, the imaging lens satisfies the following conditional expressions:

−2.8<f2/f<−0.5 (1)

0.0<(r1+r2)/(r1−r2)<2.3 (2)

where f2 represents a focal length (mm) of the second lens, f represents a focal length (mm) of an entire system, r1 represents a radius of curvature (mm) of the object-side surface of the first lens, and r2 represents a radius of curvature (mm) of an image-side surface of the first lens.

### TECHNICAL FIELD

The present invention relates to an imaging lens suitable for an imaging device using a solid state image sensor, and an imaging device using the imaging lens.

### BACKGROUND ART

Image sensors using a solid state image sensor such as a charge coupled devices (CCD) image sensor and a complementary metal-oxide semiconductor (CMOS) image sensor have been developed to achieve high performance and miniaturization. As a result, devices including an imaging device have been widely used in recent years. Among these devices, a vehicle camera and a monitoring camera, for example, are expected to provide an angle of view equal to or greater than 180 degrees in order to photograph as wide a range as possible. In addition, needless to say, there is also a demand for miniaturization and cost reduction. In order to meet these demands, an imaging lens including four lenses has been proposed.

In a conventional imaging lens including four lenses, a glass lens having environment resistance and high optical performance is often used as a lens arranged nearest to an object side. In addition, a spherical lens is generally used as the lens arranged nearest to the object side from the viewpoint of cost reduction and manufacturability. However, the lens arranged nearest to the object side is required to be an aspherical lens in order to respond to a recent request for high performance and reduction in an entire optical length (reduction in height) while widening the angle of view and reducing the cost. In particular, in order to enhance design and miniaturization of a device including the imaging lens, an object-side surface of the lens arranged nearest to the object side is desirably formed to have an almost plane surface.

In this regard, Patent Literature 1 and 2 disclose an imaging lens including four lenses, in which an aspherical surface is used for a lens arranged nearest to an object side, and an image-side surface is formed to have an almost plane surface.

### CITATION LIST

### Patent Literature

Patent Literature 1: JP 2011-81425 A

Patent Literature 2: JP 2008-281859 A

Patent Literature 3: JP 2007-25499 A

### SUMMARY OF INVENTION

### Technical Problem

In the imaging lens described in Patent Literature 1, however, the angle of view is not sufficiently widened. In the imaging lens of Patent Literature 2, since refractive power of a second lens is weak, neither the wide angle of view nor the reduction in height is achieved.

Furthermore, Patent Literature 3 discloses an imaging lens, in which a lens arranged nearest to an object side has a meniscus shape with a convex surface facing the object side. However, neither the wide angle of view nor the reduction in height is achieved.

The present invention has been made for solving these problems, and a purpose thereof is to provide an imaging lens including four lenses capable of widening the angle of view and reducing the height compared to the conventional imaging lens while reducing the cost and securing the optical performance. Another purpose of the present invention is to provide an imaging device using the imaging lens.

### Solution to Problem

In order to achieve at least one of the above-mentioned purposes, an imaging lens reflecting one aspect of the present invention includes a first lens, a second lens, a third lens, and a fourth lens in order from an object side. The first lens and the second lens have negative refractive power. An object-side surface of the first lens is formed to have an aspherical shape. Moreover, the imaging lens satisfies the following conditional expressions:

−2.8<f2/f<−0.5 (1)

0.0<(r1+r2)/(r1−r2)<2.3 (2)

where
f2 represents a focal length (mm) of the second lens,
f represents a focal length (mm) of an entire system,
r1 represents a radius of curvature (mm) of the object-side surface of the first lens, and
r2 represents a radius of curvature (mm) of an image-side surface of the first lens.

By using a negative lens as the first lens and the second lens, a principal point position of the entire system can be brought closer to an image side. As a result, the angle of view can be further widened. Furthermore, by using the aspherical surface as the object-side surface of the first lens, a central part and a peripheral part of the first lens have different refractive power from each other. As a result, aberration of both an axial luminous flux and a peripheral luminous flux can be appropriately corrected.

The first lens satisfying the conditional expression (2) may have a biconcave shape, where the radius of curvature of the object-side surface is gentler than that of the image-side surface. Alternatively, the first lens satisfying the conditional expression (2) may be a meniscus lens which has a gentle convex surface facing the object side. Supposing that the object-side surface of the first lens is an aspherical surface, light at an angle equal to or greater than 180 degrees cannot enter a plane surface or a concave surface. When the lens has a gentle convex surface, light at an angle greater than 180 degrees enters the object-side surface of the first lens at a large incident angle, thereby generating large aberration. In this regard, the imaging lens of the present invention includes the first lens having the aspherical surface on the object-side surface, the peripheral part of which is formed to have a convex shape. As a result, light at a large angle can enter the first lens at a small incident angle, thereby reducing the aberration in a wide-angle lens greater than 180 degrees.

When the value of the conditional expression (1) exceeds the lower limit, the second lens has the strong negative refractive power. As a result, the principal point position is brought closer to an image surface, which is advantageous for widening the angle of view. On the other hand, when the value of the conditional expression (1) falls below the upper limit, the negative refractive power of the second lens is not too strong, thereby preventing spherical aberration and coma as well as an increase in error sensitivity. Furthermore, the imaging lens of the present invention desirably satisfies the following conditional expression (1′).

−2.3<f2/f<−1.0 (1′)

When the value of the conditional expression (2) exceeds the lower limit, the first lens is a biconcave lens, where the radius of curvature of the object-side surface is larger than that of the image-side surface. As a result, the principal point position of the first lens is brought closer to the image side, which is advantageous for widening the angle of view. When the value of the conditional expression (2) falls below the upper limit, the first lens is a meniscus lens which has a gentle convex surface facing the object-side. As a result, the first lens does not project to the object side, which is advantageous for reducing the height. Furthermore, the imaging lens of the present invention desirably satisfies the following conditional expression (2′).

0.5<(r1+r2)/(r1−r2)<1.8 (2′)

An imaging device of the present invention is characterized by including the above-mentioned imaging lens.

### Advantageous Effects of Invention

The present invention can provide an imaging lens including four lenses capable of widening the angle of view and reducing the height compared to a conventional imaging lens while reducing the cost and securing the optical performance. The present invention can also provide an imaging device using the imaging lens.

### BRIEF DESCRIPTION OF DRAWINGS

FIG. 1 is an exaggerated view illustrating one example of an object-side surface S1 of a first lens.

FIG. 2 is a perspective view of an imaging device LU according to the present embodiment.

FIG. 3 is a cross-sectional view of an imaging lens according to Example 1.

FIG. 4 illustrates spherical aberration (a), astigmatism (b), and distortion (c)) of the imaging lens according to Example 1.

FIG. 5 is aberration diagrams of meridional coma (a) and (b) according to Example 1.

FIG. 6 is a cross-sectional view of an imaging lens according to Example 2.

FIG. 7 illustrates spherical aberration (a), astigmatism (b), and distortion (c)) of the imaging lens according to the Example 2.

FIG. 8 is aberration diagrams of meridional coma (a) and (b) according to the Example 2.

FIG. 9 is a cross-sectional view of an imaging lens according to Example 3.

FIG. 10 illustrates spherical aberration (a), astigmatism (b), and distortion (c)) of the imaging lens according to Example 3.

FIG. 11 is aberration diagrams of meridional coma (a) and (b) according to Example 3.

FIG. 12 is a cross-sectional view of an imaging lens according to Example 4.

FIG. 13 illustrates spherical aberration (a), astigmatism (b), and distortion (c)) of the imaging lens according to Example 4.

FIG. 14 is aberration diagrams of meridional coma (a) and (b) according to Example 4.

FIG. 15 is a cross-sectional view of an imaging lens according to Example 5.

FIG. 16 illustrates spherical aberration (a), astigmatism (b), and distortion (c)) of the imaging lens according to Example 5.

FIG. 17 is aberration diagrams of meridional coma (a) and (b) according to Example 5.

FIG. 18 is a cross-sectional view of an imaging lens according to Example 6.

FIG. 19 illustrates spherical aberration (a), astigmatism (b), and distortion (c)) of the imaging lens according to Example 6.

FIG. 20 is aberration diagrams of meridional coma (a) and (b) according to Example 6.

FIG. 21 is a cross-sectional view of an imaging lens according to Example 7.

FIG. 22 illustrates spherical aberration (a), astigmatism (b), and distortion (c)) of the imaging lens according to Example 7.

FIG. 23 is aberration diagrams of meridional coma (a) and (b) according to Example 7.

### DESCRIPTION OF EMBODIMENTS

Hereinafter, embodiments of the present invention will be described referring to the accompanying drawings. FIG. 2 is a perspective view of a vehicle camera 1 using an imaging device according to the present embodiment. The imaging device of the vehicle camera 1 includes a CMOS image sensor IM and an imaging lens LN. The imaging lens LN images an object on a photoelectric conversion part (light receiving surface) of the image sensor IM. An image signal is output from the CMOS image sensor IM to a vehicle computer (not shown in the figure) via a cable 2.

The imaging lens LN includes a first lens, a second lens, a third lens, and a fourth lens in order from an object side. The first lens and the second lens have negative refractive power. An object-side surface of the first lens is formed to have an aspherical shape. Moreover, the imaging lens satisfies the following conditional expressions:

−2.8<f2/f<−0.5 (1)

0.0<(r1+r2)/(r1−r2)<2.3 (2)

where
f2 represents a focal length (mm) of the second lens,
f represents a focal length (mm) of an entire system,
r1 represents a radius of curvature (mm) of the object-side surface of the first lens, and
r2 represents a radius of curvature (mm) of an image-side surface of the first lens.

Hereinafter, a preferable embodiment will be described.

In the above-mentioned imaging lens, the third lens and the fourth lens preferably have positive refractive power. When the third lens and the fourth lens have the positive refractive power, and are combined with the first lens and the second lens having the negative refractive power, the entire system is configured as a retro-focus type, which is advantageous for widening the angle of view. In addition, strong positive refractive power is required in order to shorten the focal length. The positive refractive power can be shared between the third lens and the fourth lens. Therefore, the refractive power of one lens is not too strong, thereby suppressing the increase in error sensitivity as well as the aberration.

Moreover, a peripheral part of the object-side surface of the first lens preferably has the positive refractive power. When the peripheral part of the object-side surface of the first lens has the positive refractive power, a ray at an angle equal to or greater than 180 degrees can enter the first lens. As a result, the angle of view can be widened to 180 degrees or more.

In addition, the first lens preferably has a concave surface facing the image side, the second lens preferably has a concave surface facing the image side, the third lens preferably has a convex surface facing the object side, and the fourth lens preferably has a convex surface facing the image side. When the first lens and the second lens have the concave surface on the image-side surface, and the third lens has the convex surface on the object-side surface, a ray at a large angle can enter each surface at an almost vertical angle, that is, at a small incident angle, thereby suppressing the aberration. When the fourth lens has the convex surface on the image-side surface, a ray can enter the image surface at a small incident angle.

Moreover, a material of the first lens preferably satisfies the following conditional expression:

40<ν1<70 (3)

where
ν1 represents an Abbe number of the first lens.

When the value of the conditional expression (3) exceeds the lower limit, chromatic aberration generated in the first lens can be reduced, thereby enhancing performance development. When the value of the conditional expression (3) falls below the upper limit, the first lens can be formed of a readily available material, which is advantageous for cost reduction. Also, the chromatic aberration is not reduced too much, which is helpful for not losing a balance of chromatic aberration correction between the first lens and the other lenses, thereby preventing excess correction. The material of the first lens desirably satisfies the following conditional expression (3′):

50<ν1<65 (3′)

Moreover, the first lens is preferably formed of a plastic material. When the first lens is formed of the plastic material, its optical surface can be easily formed to have an aspherical surface. The plastic material is also advantageous for cost reduction.

Moreover, an aperture stop is preferably provided between the third lens and the fourth lens. When the aperture stop is arranged between the third lens and the fourth lens, an effective diameter of the third lens and the fourth lens can be reduced. Therefore, higher-order aberration can be reduced even when the third lens and the fourth lens have the strong positive refractive power. Meanwhile, an axial ray height is increased by arranging the aperture stop. As a result, the refractive power of the third lens and the fourth lens contributes largely to the focal length of the entire system, which is helpful for shortening the focal length, and advantageous for widening the angle of view.

Assuming that a maximum plane angle between the object-side surface of the first lens and a line perpendicular to an optical axis is θ1 (°), a distance between the optical axis and a position of the angle θ1 is h1, and a plane angle between the object-side surface and a line perpendicular to the optical axis intersecting at a position of a distance h1/5 from the optical axis is θ2 (°), the following conditional expression is preferably satisfied:

θ1>θ2·6 (4)

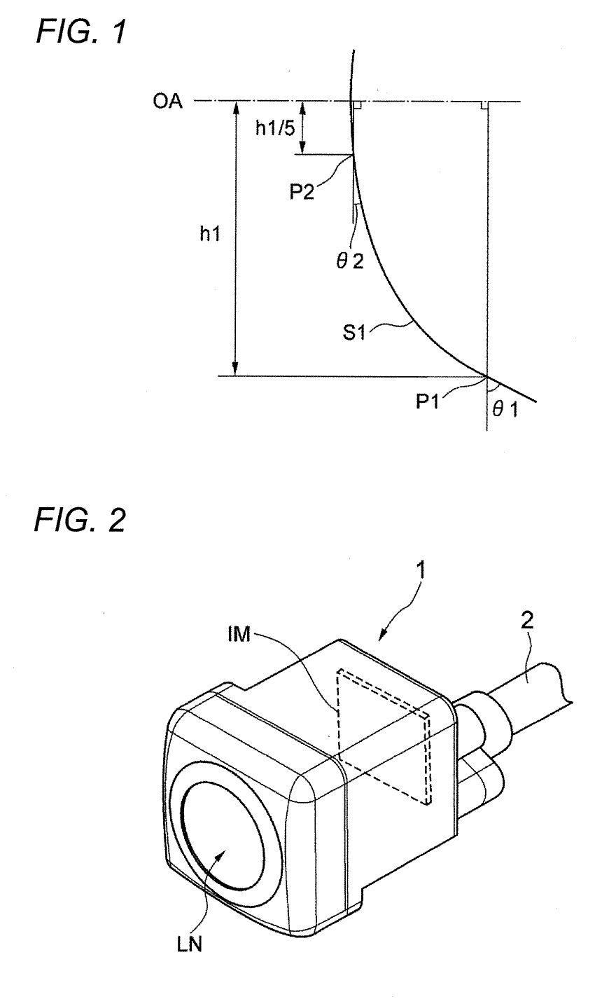

FIG. 1 is an exaggerated view illustrating one example of an object-side surface S1 of the first lens. In FIG. 1, a maximum plane angle θ1(°) between the object-side surface S1 of the first lens and a line perpendicular to an optical axis OA is obtained at a position P1. In this case, assuming that a distance between the optical axis OA and the position P1 is h1, and a plane angle between the object-side surface S1 and a line perpendicular to the optical axis OA intersecting at a position P2 of a distance h1/5 from the optical axis OA is θ2 (°), the conditional expression (4) is satisfied. When the conditional expression (4) is satisfied, a plane angle of a central part of the object-side surface of the first lens is small, and a plane angle of a peripheral part of the object-side surface of the first lens is large. As a result, the central part does not project, which is advantageous for reducing the height. When the plane angle of the peripheral part is large, a ray at a large angle can enter the surface at a small incident angle, thereby suppressing the aberration. Furthermore, the imaging lens of the present invention desirably satisfies the following conditional expression (4′).

θ1>θ2·10 (4′)

Moreover, the above-mentioned imaging lens preferably satisfies the following conditional expression:

−0.06<f/r1<0.06 (5)

When the radius of curvature of the object-side surface of the first lens satisfies the range of the conditional expression (5), the object-side surface of the first lens is formed to have an almost plane surface. When the value of the conditional expression (5) falls below the upper limit, a convex shape of the object-side surface of the first lens is not too strong, thereby reducing the spherical aberration. At the same time, a principal point position of the first lens is not brought closer to the image side in relation to the lens. Therefore, the reduction in height can be enhanced. When the value of the conditional expression (5) exceeds the lower limit, a concave shape of the object-side surface of the first lens is not too strong. As a result, a ray at a large angle greater than 180 degrees can enter the lens, thereby contributing to widening the angle of view. The angle of view can be widened by forming a convex shape on the peripheral part of the aspherical shape. In this regard, since the radius of curvature is not much different between the central part and the peripheral part, manufacturing error sensitivity can be reduced so as to increase manufacturability. Furthermore, the imaging lens of the present invention desirably satisfies the following conditional expression (5′).

−0.04<f/r1<0.04 (5′)

Moreover, the above-mentioned imaging lens preferably satisfies the following conditional expression:

1.8<f3/f<4.3 (6)

where
f3 represents a focal length (mm) of the third lens.

When the value of the conditional expression (6) exceeds the lower limit, the positive refractive power of the third lens is not too strong, thereby reducing the spherical aberration and the coma. When the value of the conditional expression (6) falls below the upper limit, the third lens has the strong positive refractive power. As a result, the principal point position of the entire system is brought closer to the image side, which is helpful for shortening the focal length, and advantageous for widening the angle of view. In addition, the chromatic aberration generated in the first lens and the second lens can be corrected. Furthermore, the imaging lens of the present invention desirably satisfies the following conditional expression (6′).

2.0<f3/f<4.0(6′)

Moreover, the above-mentioned imaging lens preferably satisfies the following conditional expression:

−30.0<fl/f<−6.0 (7)

where f1 represents a focal length (mm) of the first lens.

When the value of the conditional expression (7) exceeds the lower limit, the first lens has the weak refractive power, thereby suppressing the spherical aberration and the coma which might occur when the refractive power is too strong. When the value of the conditional expression (7) falls below the upper limit, the first lens has the negative refractive power. As a result, it contributes to shortening the focal length of the entire system, which is advantageous for widening the angle of view. Furthermore, the imaging lens of the present invention desirably satisfies the following conditional expression (7′).

−20.0<fl/f<−7.0 (7′)

Moreover, the above-mentioned imaging lens preferably satisfies the following conditional expression:

2.0<f34/f<4.0 (8)

where
f34 represents a composite focal length (mm) of the third lens and the fourth lens.

The conditional expression (8) defines a preferable range of the composite focal length of the third lens and the fourth lens. When the value of the conditional expression (8) exceeds the lower limit, composite refractive power of the third lens and the fourth lens is not too strong in relation to the focal length of the entire system, thereby suppressing the spherical aberration and the coma. When the value of the conditional expression (8) falls below the upper limit, the positive refractive power is strong at a position near the image surface, which is helpful for shortening the focal length, and advantageous for widening the angle of view. Furthermore, the imaging lens of the present invention desirably satisfies the following conditional expression (8′).

2.5<f34/f<3.5 (8′)

Moreover, the above-mentioned imaging lens preferably satisfies the following conditional expression:

−1.0≦(r5+r6)/(r5−r6)<−0.2 (9)

where
r5 represents a radius of curvature (mm) of the object-side surface of the third lens, and
r6 represents a radius of curvature (mm) of the image-side surface of the third lens.

The conditional expression (9) defines a preferable shape of the third lens. When the value of the conditional expression (9) exceeds the lower limit, the image-side surface of the third lens has a gentle convex surface. As a result, the strong positive refractive power of the third lens can be shared between the convex surface on the object side and the convex surface on the image side. Therefore, the refractive power of the convex surface on the object side is not too strong, thereby preventing the spherical aberration and the coma. When the value of the conditional expression (9) falls below the upper limit, a convex shape of the image-side surface of the third lens is not too strong. Also, light of a peripheral image height does not enter the image-side surface of the third lens at too large an incident angle, thereby suppressing an increase in the coma. Furthermore, the imaging lens of the present invention desirably satisfies the following conditional expression (9′).

−0.8<(r5+r6)/(r5−r6)<−0.3 (9′)

Moreover, the above-mentioned imaging lens preferably satisfies the following conditional expression:

0.8<f3/f4<2.0 (10)

where
f3 represents a focal length (mm) of the third lens, and
f4 represents a focal length (mm) of the fourth lens.

The value of the conditional expression (10) defines a preferable range of a ratio of the focal length between the third lens and the fourth lens. By satisfying the conditional expression (10), a balance of the refractive power between the third lens and the fourth lens is improved, thereby widening the angle of view as well as correcting the aberration. Furthermore, the imaging lens of the present invention desirably satisfies the following conditional expression (10′).

1.0<f3/f4<1.8 (10′)

In addition, the image-side surface of the second lens is preferably an aspherical surface. As a result, in an effective diameter of the image-side surface of the second lens, a central part and a peripheral part can have different power from each other, which is advantageous for correcting the aberration.

Moreover, the above-mentioned imaging lens may include a lens having substantially no refractive power.

### EXAMPLES

Next, examples suitable for the above-mentioned embodiment will be described. However, the present invention is not limited by the examples described below. Reference signs used in the examples have the following meanings (“mm” is used as a unit of length except for wavelength).

FL: a focal length (mm) of an entire system of an image lens
BF: a back focal length (mm) (a distance to a paraxial image surface when cover glass is converted to an air conversion length)
Fno: f-number
w: a half viewing angle)(°)
Ymax: a half diagonal length (mm) of an imaging surface of a solid state image sensor.
TL: a distance (mm) on an optical axis from a lens surface arranged nearest to an object side of the entire system of the imaging lens to a rear focal point (the “rear focal point” is an image point when a ray parallel to the optical axis enters the imaging lens, and the cover glass is converted to the air conversion length)
r: a radius of curvature (mm) of a refractive surface
d: an axial surface distance (mm)
nd: a refractive index of d line of a lens material at a normal temperature
vd: an Abbe number of the lens material
STO: an aperture stop
eff.diameter: an effective diameter

In each example, a surface having a surface number followed by “*” is a surface having an aspherical surface. Assuming that an apex of a surface is an origin, an optical axis direction is an x-axis, and a height in a direction perpendicular to the optical axis is h, the aspherical surface is expressed in “Formula 1” below:

$$X = \frac{{h}^{2} / R}{1 + \sqrt{1 - ( 1 + K ) {h}^{2} / {R}^{2}}} + \sum {A}_{i} {h}^{i} \qquad [ Formula 1 ]$$

where
Ai represents an i-order aspherical coefficient,
R represents a radius of curvature, and
K represents a conic constant.

Hereinafter (including lens data in tables), a power of 10 (for example, 2.5·10⁻⁰²) is expressed by using E (for example, 2.5e-002). In the lens data, a surface number starting from 1 is allotted to each surface in order from an object side of a first lens. A unit “mm” is used for indicating all the lengths described in the examples.

Regarding a meaning of a paraxial radius of curvature described in a scope of claims and the examples, in actual lens measurement, an approximate radius of curvature can be regarded as the paraxial radius of curvature. The approximate radius of curvature is obtained by fitting, with a least squares method, a shape measurement value in the vicinity of a lens center (specifically, a central region within 10% of an effective diameter of a lens). Alternatively, when using a second-order aspherical coefficient, a radius of curvature obtained according to an aspherical defining equation with the second-order aspherical coefficient considered in a reference radius of curvature can be regarded as the paraxial radius of curvature. (Refer to, for example, “Lens Design Method” by Yoshiya Matsui, published by Kyoritsu Shuppan Co., Ltd., pages 41-42, as a reference.)

### Example 1

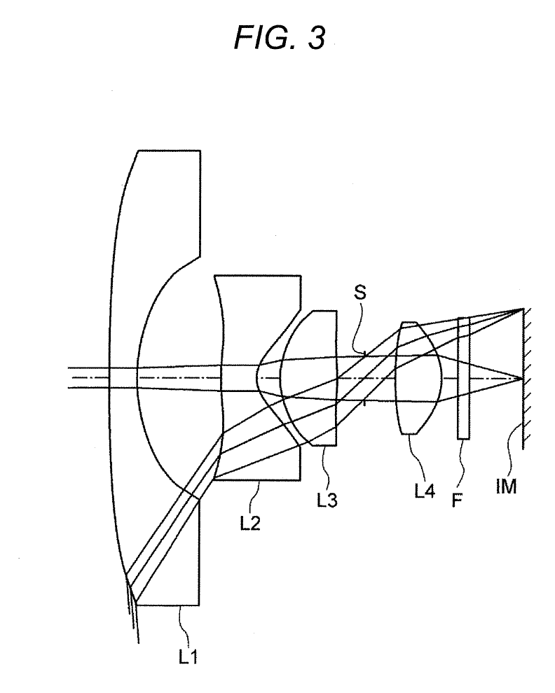

Lens data of Example 1 is shown in Table 1. FIG. 3 is a cross-sectional view of a lens according to Example 1. An imaging lens according to Example 1 includes a first lens L1, a second lens L2, a third lens L3, an aperture stop S, and a fourth lens L4 in order from an object side. The first lens L1 and the second lens L2 have negative refractive power, and the third lens L3 and the fourth lens L4 have positive refractive power. The first lens L1 is formed of a plastic material. An object-side surface of the first lens L1 is formed to have an aspherical shape. A peripheral part of the object-side surface of the first lens L1 has positive refractive power. The first lens L1 has a concave surface facing an image side, the second lens L2 has a concave surface facing the image side, the third lens L3 has a convex surface facing the object side, and the fourth lens L4 has a convex surface facing the image side. F is a parallel plate such as cover glass and an IR cut filter, and IM is an imaging surface of a solid state image sensor.

TABLE 1
[Example 1]
Reference Wave Length = 587.56 nm
unit: mm

| surface | | | | | |
|---|---|---|---|---|---|
| number | r | d | nd | vd | eff. diameter |
| 1* | 1e+018 | 0.8000 | 1.54470 | 55.99 | 12.968 |
| 2* | 5.7049 | 2.3699 | | | 6.891 |
| 3* | 3.6648 | 1.0101 | 1.54470 | 55.99 | 5.808 |
| 4* | 0.7497 | 0.6532 | | | 3.912 |
| 5* | 2.1522 | 1.6597 | 1.63469 | 23.86 | 3.763 |
| 6* | −5.5145 | 0.7689 | | | 2.859 |
| STO | INFINITY | 0.8498 | | | 1.201 |
| 8* | 5.5351 | 1.3217 | 1.54470 | 56.00 | 2.889 |
| 9* | −1.4688 | 0.5000 | | | 3.054 |
| 10 | INFINITY | 0.3000 | 1.56400 | 47.00 | 3.329 |
| 11 | INFINITY | 1.5397 | | | 3.375 |

Surface number: aspherical coefficient
1:
K = 0.00000e+000, A4 = 6.96143e−004, A6 = −3.86461e−006,
A8 = −1.06354e−007, A10 = 1.41062e−009
2:
K = 0.00000e+000, A4 = −3.12737e−004, A6 = 6.88601e−004,
A8 = −7.82132e−005, A10 = 4.60432e−006
3:
K = −5.00000e+001, A4 = −1.90113e−002, A6 = 2.15327e−003,
A8 = −1.20466e−004, A10 = 2.87551e−006
4:
K = −1.94492e+000, A4 = 1.01466e−002, A6 = −6.21379e−004,
A8 = −2.54781e−003, A10 = 4.05222e−004
5:
K = 0.00000e+000, A4 = −4.33199e−002, A6 = 2.85933e−002,
A8 = −9.67521e−003, A10 = 1.15315e−003
6:
K = 0.00000e+000, A4 = 2.07964e−002, A6 = 2.48808e−002,
A8 = −2.56711e−002, A10 = 1.32981e−002, A12 = −2.25096e−003
8:
K = 0.00000e+000, A4 = −2.18040e−002, A6 = 6.65018e−003,
A8 = 1.69852e−003, A10 = 1.88678e−004
9:
K = −2.13847e+000, A4 = −2.72322e−002, A6 = 1.44832e−002,
A8 = −9.54128e−003, A10 = 3.48938e−003

| | |
|---|---|
| FL | 1.173 |
| Fno | 2.00 |
| w | 187.00 |
| Ymax | 1.931 |
| BF | 2.232 |
| TL | 11.665 |

| Elem | Surfs | Focal Length | Diameter |
|---|---|---|---|
| 1 | 1-2 | −10.4735 | 12.968 |
| 2 | 3-4 | −1.9710 | 5.808 |
| 3 | 5-6 | 2.6628 | 3.763 |
| 4 | 8-9 | 2.2830 | 3.054 |

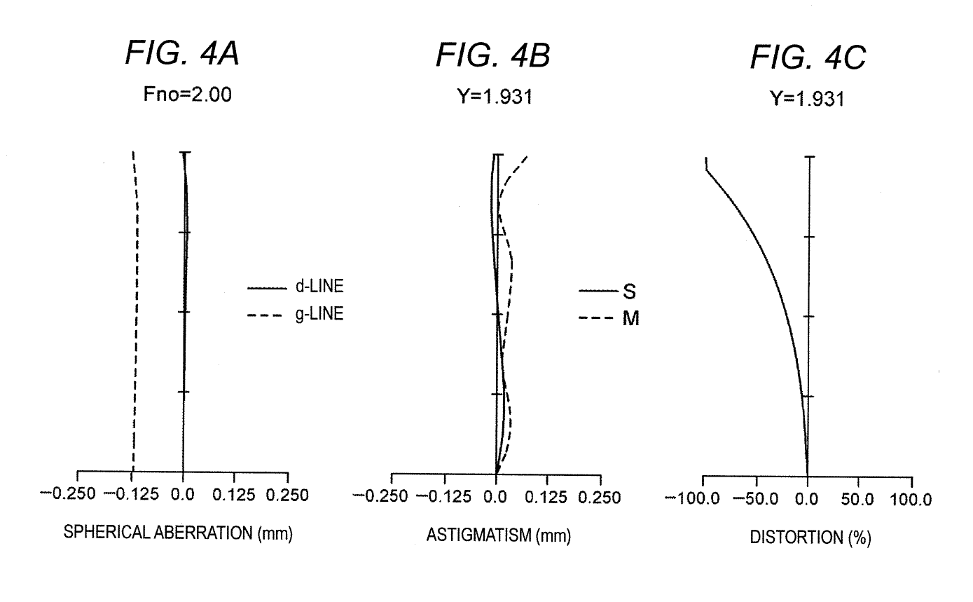

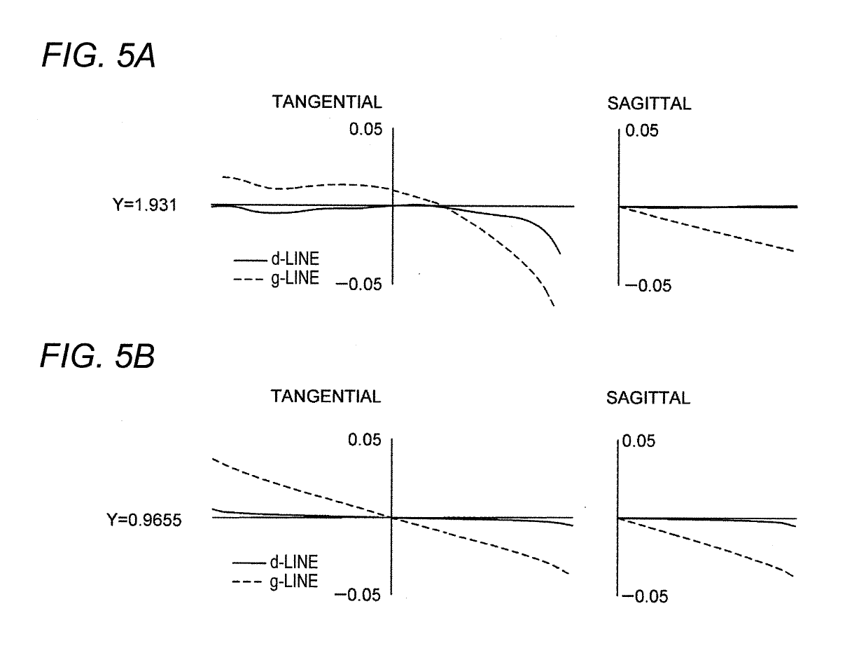

FIG. 4 is aberration diagrams (spherical aberration (a), astigmatism (b), and distortion (c)) of Example 1. FIG. 5 illustrates meridional coma (a) and (b)). In the spherical aberration diagram and the meridional coma diagram, solid lines and dotted lines illustrate an amount of spherical aberration of d-line and an amount of spherical aberration of g-line respectively. In the astigmatism diagram, solid lines and dotted lines illustrate a sagittal plane and a meridional plane respectively (the same shall apply hereinafter).

### Example 2

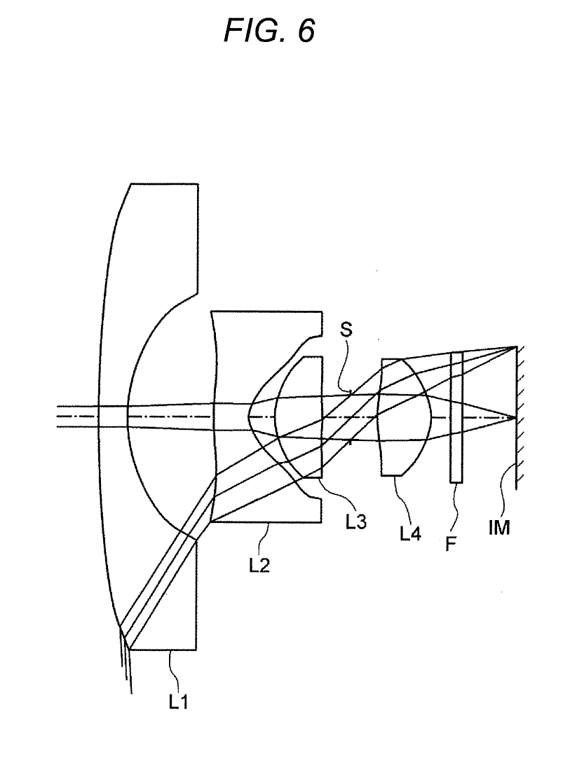

Lens data of Example 2 is shown in Table 2. FIG. 6 is a cross-sectional view of a lens according to Example 2. An imaging lens according to Example 2 includes a first lens L1, a second lens L2, a third lens L3, an aperture stop S, and a fourth lens L4 in order from an object side. The first lens L1 and the second lens L2 have negative refractive power, and the third lens L3 and the fourth lens L4 have positive refractive power. The first lens L1 is formed of a plastic material. An object-side surface of the first lens L1 is formed to have an aspherical shape. A peripheral part of the object-side surface of the first lens L1 has positive refractive power. The first lens L1 has a concave surface facing an image side, the second lens L2 has a concave surface facing the image side, the third lens L3 has a convex surface facing the object side, and the fourth lens L4 has a convex surface facing the image side. F is a parallel plate such as cover glass and an IR cut filter, and IM is an imaging surface of a solid state image sensor.

TABLE 2
[Example 2]
Reference Wave Length = 587.56 nm
unit: mm

| surface | | | | | eff. |
|---|---|---|---|---|---|
| number | r | d | nd | vd | diameter |
| 1* | 1e+018 | 0.8000 | 1.54470 | 55.99 | 12.665 |
| 2* | 4.5554 | 2.3208 | | | 6.646 |
| 3* | 3.5404 | 0.9325 | 1.54470 | 55.99 | 5.680 |
| 4* | 0.7386 | 0.6815 | | | 3.481 |
| 5* | 1.9061 | 1.3063 | 1.63469 | 23.86 | 3.294 |
| 6* | −8.0154 | 0.7780 | | | 2.715 |
| STO | INFINITY | 0.7171 | | | 1.219 |
| 8* | 4.3032 | 1.4616 | 1.54470 | 56.00 | 2.663 |
| 9* | −1.5587 | 1.7358 | | | 3.164 |
| 10 | INFINITY | 0.3000 | 1.56400 | 47.00 | 3.754 |
| 11 | INFINITY | 0.2919 | | | 3.798 |

Surface number: aspherical coefficient
1:
K = 0.00000e+000, A4 = 7.76977e−004, A6 = −2.79927e−006,
A8 = −1.18676e−007, A10 = 8.50507e−010
2:
K = 0.00000e+000, A4 = −1.29350e−003, A6 = 9.46875e−004,
A8 = −1.28640e−004, A10 = 7.58000e−006
3:
K = −3.11243e+001, A4 = −2.07764e−002, A6 = 2.30146e−003,
A8 = −8.28633e−005, A10 = −4.21018e−008
4:
K = −1.89093e+000, A4 = 5.99182e−002, A6 = −9.18142e−003,
A8 = −7.34492e−003, A10 = 1.47135e−003
5:
K = 0.00000e+000, A4 = −2.72150e−002, A6 = 2.27525e−002,
A8 = −6.61266e−003, A10 = −3.00618e−004
6:
K = 0.00000e+000, A4 = 1.38298e−002, A6 = 3.82173e−002,
A8 = −3.04123e−002, A10 = 1.36523e−002, A12 = −2.69843e−003
8:
K = 0.00000e+000, A4 = −3.56221e−002, A6 = 1.53074e−002,
A8 = −1.12135e−002, A10 = 2.16767e−003
9:
K = −2.00000e+000, A4 = −2.07585e−002, A6 = 5.81866e−003,
A8 = −1.88585e−003, A10 = −4.66717e−004

| | |
|---|---|
| FL | 1.163 |
| Fno | 2.00 |
| w | 187.00 |
| Ymax | 1.930 |
| BF | 2.219 |
| TL | 11.217 |

| Dem | Surfs Focal | Length | Diameter |
|---|---|---|---|
| 1 | 1-2 | −8.3632 | 12.665 |
| 2 | 3-4 | −1.9411 | 5.680 |
| 3 | 5-6 | 2.5569 | 3.294 |
| 4 | 8-9 | 2.3032 | 3.164 |

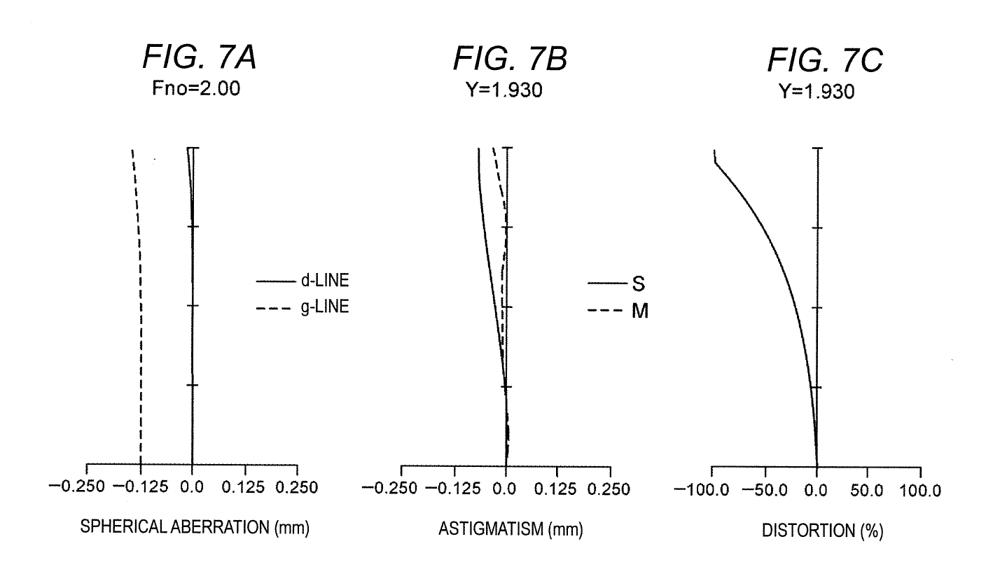

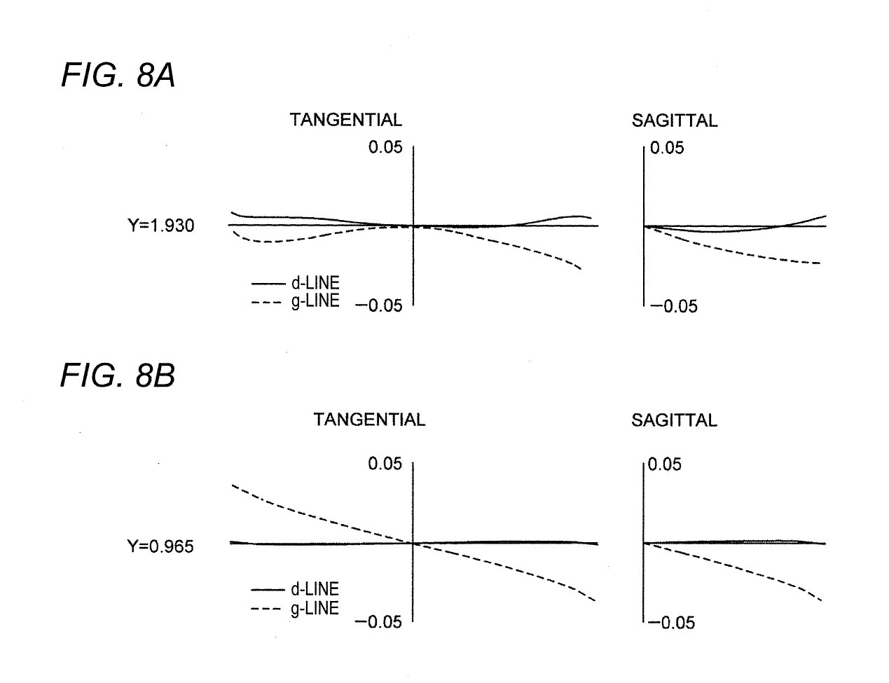

FIG. 7 is aberration diagrams (spherical aberration (a), astigmatism (b), and distortion (c)) of Example 2. FIG. 8 illustrates meridional coma (a) and (b)).

### Example 3

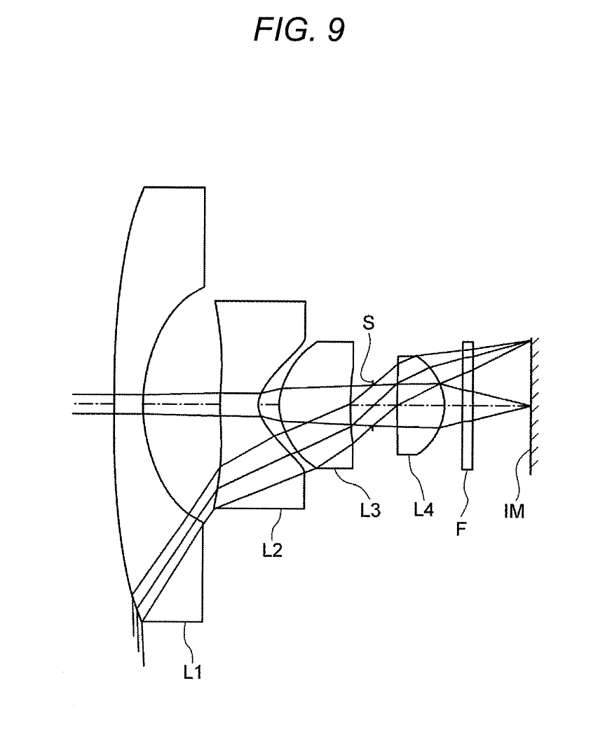

Lens data of Example 3 is shown in Table 3. FIG. 9 is a cross-sectional view of a lens according to Example 3. An imaging lens according to Example 3 includes a first lens L1, a second lens L2, a third lens L3, an aperture stop S, and a fourth lens L4 in order from an object side. The first lens L1 and the second lens L2 have negative refractive power, and the third lens L3 and the fourth lens L4 have positive refractive power. The first lens L1 is formed of a plastic material. An object-side surface of the first lens L1 is formed to have an aspherical shape. A peripheral part of the object-side surface of the first lens L1 has positive refractive power. The first lens L1 has a concave surface facing an image side, the second lens L2 has a concave surface facing the image side, the third lens L3 has a convex surface facing the object side, and the fourth lens L4 has a convex surface facing the image side. F is a parallel plate such as cover glass and an IR cut filter, and IM is an imaging surface of a solid state image sensor.

TABLE 3
[Example 3]
Reference Wave Length = 587.56 nm
unit: mm

| surface | | | | | |
|---|---|---|---|---|---|
| number | r | d | nd | vd | eff. diameter |
| 1* | 235.6060 | 0.8000 | 1.54470 | 55.99 | 12.640 |
| 2* | 5.7550 | 2.2146 | | | 6.885 |
| 3* | 4.9447 | 1.0887 | 1.54470 | 55.99 | 6.071 |
| 4* | 0.8385 | 0.5964 | | | 3.933 |
| 5* | 2.0370 | 2.0692 | 1.63469 | 23.86 | 3.692 |
| 6* | −14.7235 | 0.6396 | | | 2.233 |
| STO | INFINITY | 0.6953 | | | 1.180 |
| 8* | 6.9822 | 1.3724 | 1.54470 | 56.00 | 2.394 |
| 9* | −1.3431 | 0.5282 | | | 2.887 |
| 10 | INFINITY | 0.3000 | 1.56400 | 47.00 | 3.647 |
| 11 | INFINITY | 1.6810 | | | 3.704 |

Surface number: aspherical coefficient
1:
K = 0.00000e+000, A4 = 6.88972e−004, A6 = −4.37326e−006,
A8 = −1.12963e−007, A10 = 1.69103e−009
2:
K = 0.00000e+000, A4 = 2.24714e−003, A6 = −2.29813e−005,
A8 = 5.70701e−006, A10 = 9.54569e−007
3:
K = −4.97988e+001, A4 = −1.76229e−002, A6 = 2.17815e−003,
A8 = −1.28225e−004, A10 = 2.83805e−006
4:
K = −1.97171e+000, A4 = 5.69974e−002, A6 = −9.78951e−003,
A8 = −3.98929e−003, A10 = 7.27255e−004
5:
K = 0.00000e+000, A4 = −5.28533e−003, A6 = 1.73548e−002,
A8 = −7.83953e−003, A10 = 7.11921e−004
6:
K = 0.00000e+000, A4 = 6.29023e−002, A6 = 7.75096e−003,
A8 = −3.29505e−002, A10 = 3.78436e−002, A12−9.97977e−003
8:
K = 0.00000e+000, A4 = −5.58407e−002, A6 = 2.16291e−002,
A8 = −1.13394e−002, A10 = 3.17925e−003
9:
K = −2.00000e+000, A4 = −5.71121e−002, A6 = 1.66570e−002,
A8 = −1.04868e−002, A10 = 2.06937e−003

| | |
|---|---|
| FL | 1.169 |
| Fno | 2.00 |
| w | 187.00 |
| Ymax | 1.925 |
| BF | 2.406 |
| TL | 11.882 |

| Elem | Surfs Focal | Length | Diameter |
|---|---|---|---|
| 1 | 1-2 | −10.8433 | 12.640 |
| 2 | 3-4 | −2.0450 | 6.071 |
| 3 | 5-6 | 2.9613 | 3.692 |
| 4 | 8-9 | 2.1956 | 2.887 |

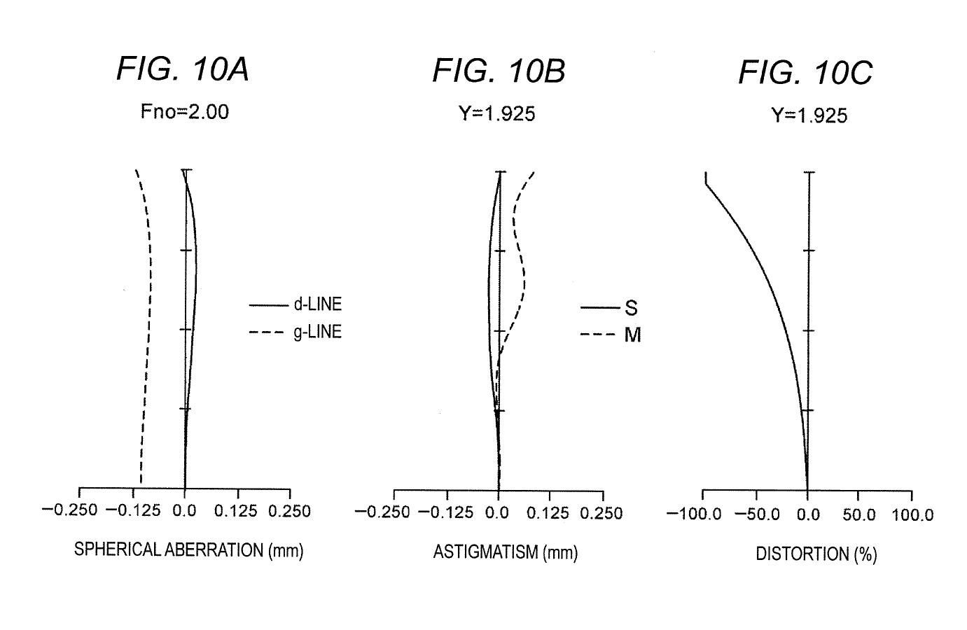

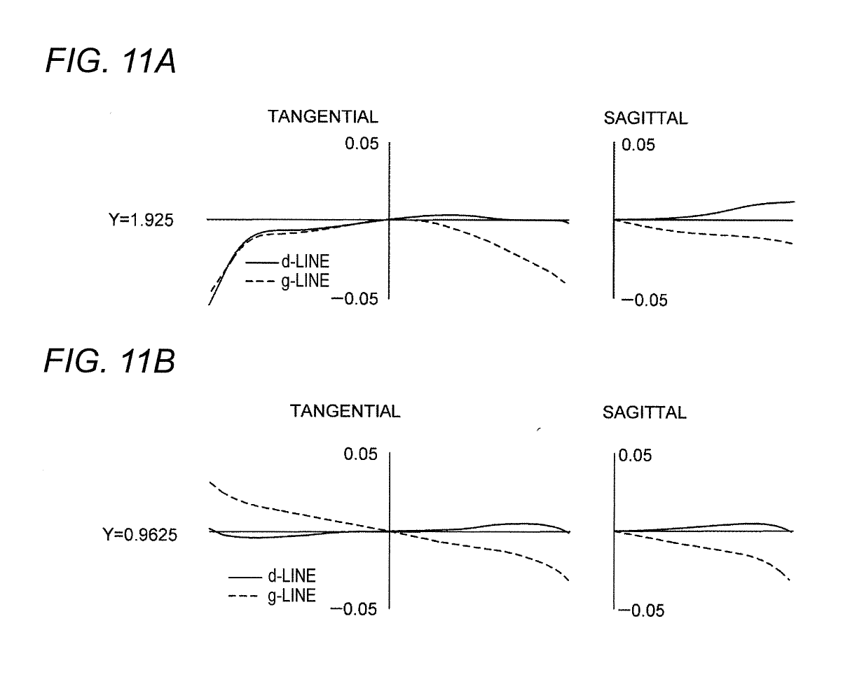

FIG. 10 is aberration diagrams (spherical aberration (a), astigmatism (b), and distortion (c)) of Example 3. FIG. 11 illustrates meridional coma (a) and (b)).

### Example 4

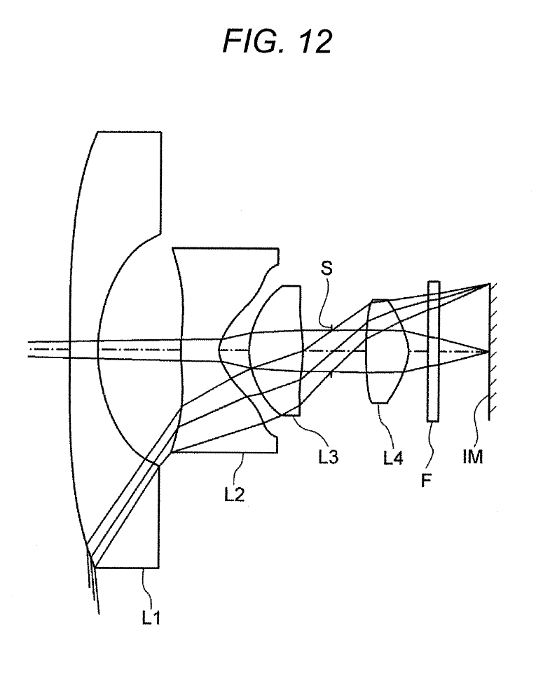

Lens data of Example 4 is shown in Table 4. FIG. 12 is a cross-sectional view of a lens according to Example 4. An imaging lens according to Example 4 includes a first lens L1, a second lens L2, a third lens L3, an aperture stop S, and a fourth lens L4 in order from an object side. The first lens L1 and the second lens L2 have negative refractive power, and the third lens L3 and the fourth lens L4 have positive refractive power. The first lens L1 is formed of a plastic material. An object-side surface of the first lens L1 is formed to have an aspherical shape. A peripheral part of the object-side surface of the first lens L1 has positive refractive power. The first lens L1 has a concave surface facing an image side, the second lens L2 has a concave surface facing the image side, the third lens L3 has a convex surface facing the object side, and the fourth lens L4 has a convex surface facing the image side. F is a parallel plate such as cover glass and an IR cut filter, and IM is an imaging surface of a solid state image sensor.

TABLE 4
[Example 4]
Reference Wave Length = 587.56 nm
unit: mm

| surface | | | | | |
|---|---|---|---|---|---|
| number | r | d | nd | vd | eff. diameter |
| 1* | 1e+018 | 0.8000 | 1.54470 | 55.99 | 12.675 |
| 2* | 5.4656 | 2.3691 | | | 6.776 |
| 3* | 4.1783 | 1.0912 | 1.54470 | 55.99 | 5.890 |
| 4* | 0.7827 | 0.8377 | | | 4.110 |
| 5* | 2.0910 | 1.5847 | 1.58313 | 29.99 | 3.762 |
| 6* | −4.3089 | 0.8535 | | | 3.079 |
| STO | INFINITY | 0.9660 | | | 1.247 |
| 8* | 6.1218 | 1.2418 | 1.54470 | 56.00 | 2.761 |
| 9* | −1.5891 | 0.5700 | | | 2.976 |
| 10 | INFINITY | 0.3000 | 1.56400 | 47.00 | 3.285 |
| 11 | INFINITY | 1.4543 | | | 3.335 |

Surface number: aspherical coefficient
1:
K = 0.00000e+000, A4 = 7.06954e−004, A6 = −3.91178e−006,
A8 = −1.06635e−007, A10 = 1.42267e−009
2:
K = 0.00000e+000, A4 = 1.39784e−004, A6 = 5.98393e−004,
A8 = −7.27836e−005, A10 = 4.73649e−006
3:
K = −5.00000e+001, A4 = −1.97803e−002, A6 = 2.14957e−003,
A8 = −1.18330e−004, A10 = 2.89387e−006
4:
K = −1.94972e+000, A4 = 1.80934e−002, A6 = −1.57153e−003,
A8 = −2.79339e−003, A10 = 3.95515e−004
5:
K = 0.00000e+000, A4 = −3.67029e−002, A6 = 2.60833e−002,
A8 = −8.70673e−003, A10 = 8.70457e−004
6:
K = 0.00000e+000, A4 = 1.75289e−002, A6 = 3.10890e−002,
A8 = −2.88965e−002, A10 = 1.22878e−002, A12 = −1.76066e−003
8:
K = 0.00000e+000, A4 = −2.15151e−002, A6 = −1.13259e−003,
A8 = 5.30843e−003, A10 = −1.07517e−004
9:
K = −3.37734e+000, A4 = −5.37472e−002, A6 = 2.65444e−002,
A8 = −1.44340e−002, A10 = 4.41219e−003

| | |
|---|---|
| FL | 1.174 |
| Fno | 2.00 |
| w | 187.00 |
| Ymax | 1.929 |
| BF | 2.216 |
| TL | 11.960 |

| Dem | Surfs Focal | Length | Diameter |
|---|---|---|---|
| 1 | 1-2 | −10.0341 | 12.675 |
| 2 | 3-4 | −1.9940 | 5.890 |
| 3 | 5-6 | 2.6565 | 3.762 |
| 4 | 8-9 | 2.4556 | 2.976 |

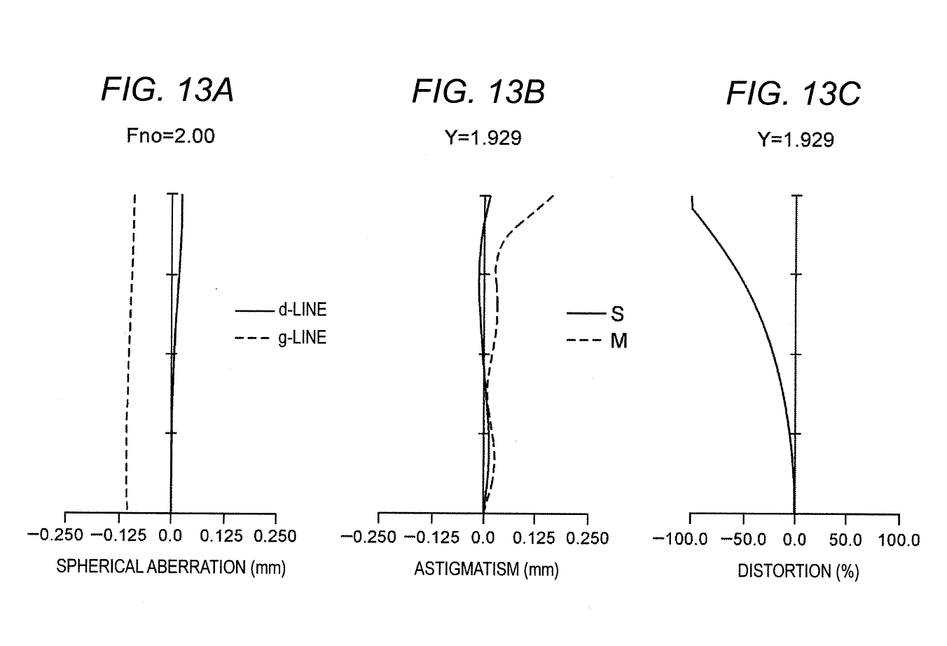

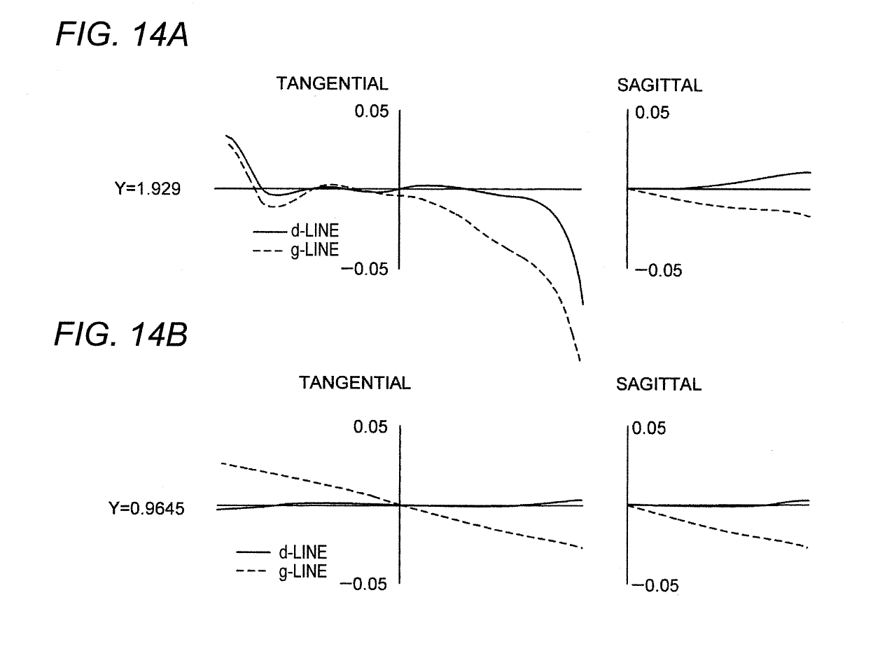

FIG. 13 is aberration diagrams (spherical aberration (a), astigmatism (b), and distortion (c)) of Example 4. FIG. 14 illustrates meridional coma (a) and (b)).

### Example 5

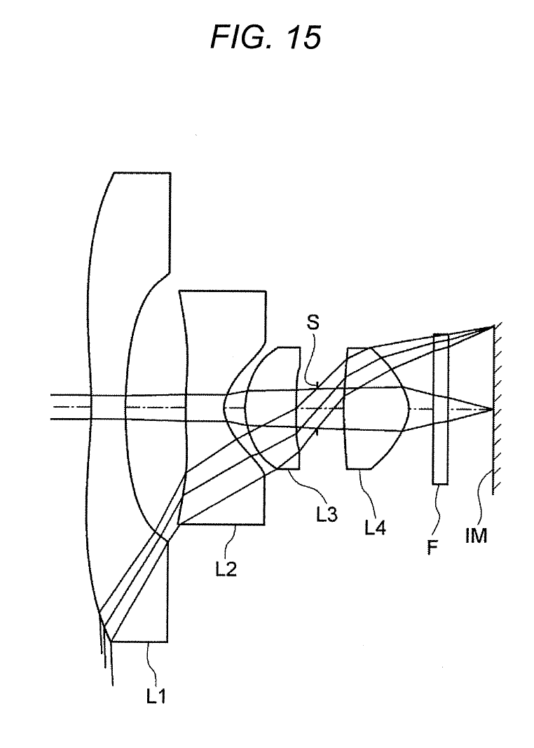

Lens data of Example 5 is shown in Table 5. FIG. 15 is a cross-sectional view of a lens according to Example 5. An imaging lens according to Example 5 includes a first lens L1, a second lens L2, a third lens L3, an aperture stop S, and a fourth lens L4 in order from an object side. The first lens L1 and the second lens L2 have negative refractive power, and the third lens L3 and the fourth lens L4 have positive refractive power. The first lens L1 is formed of a plastic material. An object-side surface of the first lens L1 is formed to have an aspherical shape. A peripheral part of the object-side surface of the first lens L1 has positive refractive power. The first lens L1 has a concave surface facing an image side, the second lens L2 has a concave surface facing the image side, the third lens L3 has a convex surface facing the object side, and the fourth lens L4 has a convex surface facing the image side. F is a parallel plate such as cover glass and an IR cut filter, and IM is an imaging surface of a solid state image sensor.

TABLE 5
[Example 5]
Reference Wave Length = 587.56 nm
unit: mm

| surface | | | | | eff. |
|---|---|---|---|---|---|
| number | r | d | nd | vd | diameter |
| 1* | −23.5910 | 0.8000 | 1.54470 | 55.99 | 10.908 |
| 2* | 17.9564 | 1.3710 | | | 6.253 |
| 3* | 9.2990 | 0.9000 | 1.53048 | 55.72 | 5.430 |
| 4* | 0.8539 | 0.4896 | | | 3.137 |
| 5* | 1.9088 | 1.1886 | 1.63200 | 23.40 | 2.827 |
| 6* | −12.4254 | 0.4800 | | | 2.007 |
| STO | INFINITY | 0.6073 | | | 0.949 |
| 8* | 4.5251 | 1.5266 | 1.53048 | 55.72 | 2.322 |
| 9* | −1.0937 | 0.5864 | | | 2.851 |
| 10 | INFINITY | 0.3000 | 1.56400 | 47.00 | 3.398 |
| 11 | INFINITY | 1.0739 | | | 3.467 |

Surface number: aspherical coefficient
1:
K = 0.00000e+000, A4 = 1.69807e−003, A6 = −1.35921e−005,
A8 = −4.74110e−008
2:
K = 0.00000e+000, A4 = 1.04215e−002, A6 = −1.42840e−003,
A8 = 1.16066e−004
3:
K = −3.45700e+001, A4 = −1.86085e−002, A6 = 1.71112e−003,
A8 = −1.31118e−005, A10 = −2.56407e−006
4:
K = −1.71331e+000, A4 = 8.97956e−002, A6 = −3.42153e−002,
A8 = −1.32515e−002, A10 = 4.55224e−003
5:
K = 0.00000e+000, A4 = 2.28289e−002, A6 = 1.13156e−002,
A8 = −1.46609e−003, A10 = −8.82522e−004
6:
K = 0.00000e+000, A4 = 6.38174e−002, A6 = 7.27780e−002,
A8 = −1.00851e−001, A10 = 1.17584e−001, A12 = −4.93281e−002
8:
K = 0.00000e+000, A4 = −7.84940e−002, A6 = 3.32129e−002,
A8 = −8.23504e−003, A10 = 1.45015e−003
9:
K = −2.00000e+000, A4 = −6.72534e−002, A6 = 2.50816e−002,
A8 = −1.84000e−002, A10 = 4.92548e−003

| | |
|---|---|
| FL | 1.170 |
| Fno | 2.00 |
| w | 187.00 |
| Ymax | 1.919 |
| BF | 1.852 |
| TL | 9.215 |

| Elem | Surfs Focal | Length | Diameter |
|---|---|---|---|
| 1 | 1-2 | −18.5920 | 10.908 |
| 2 | 3-4 | −1.8404 | 5.430 |
| 3 | 5-6 | 2.7049 | 2.827 |
| 4 | 8-9 | 1.8330 | 2.851 |

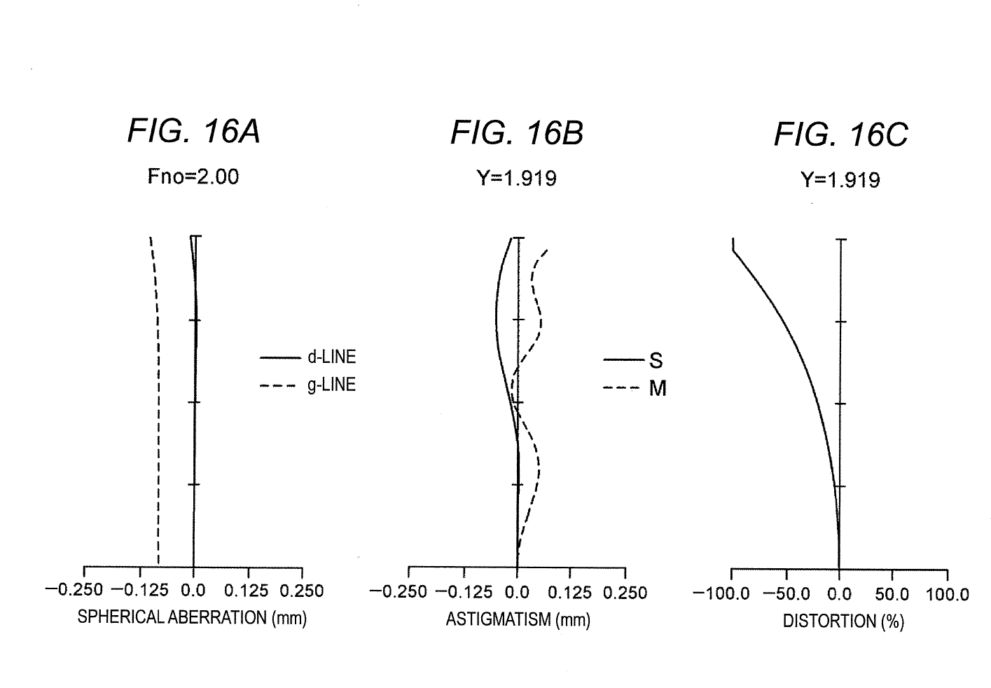

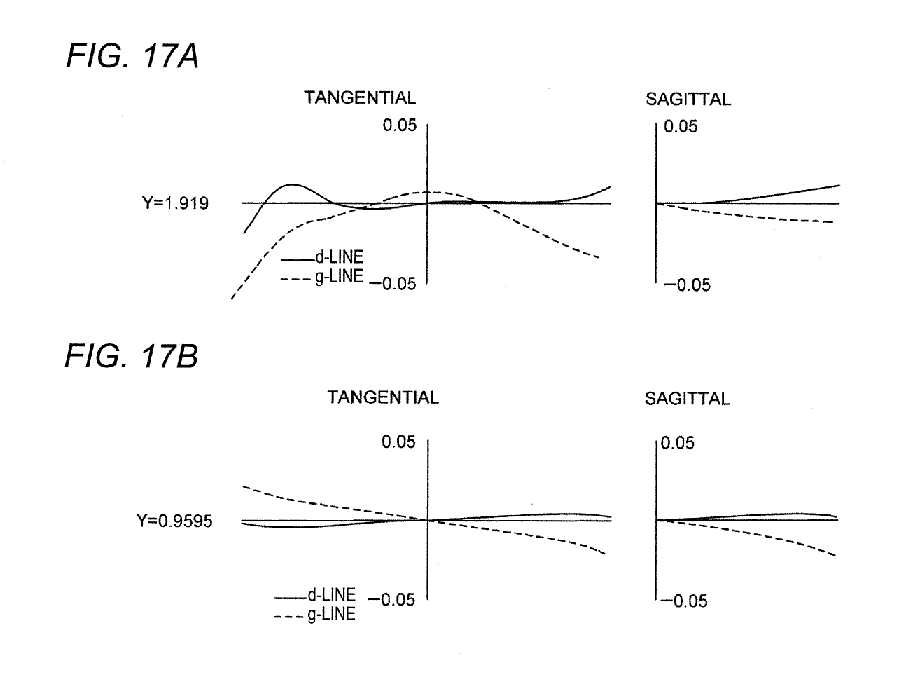

FIG. 16 is aberration diagrams (spherical aberration (a), astigmatism (b), and distortion (c)) of Example 5. FIG. 17 illustrates meridional coma (a) and (b)).

### Example 6

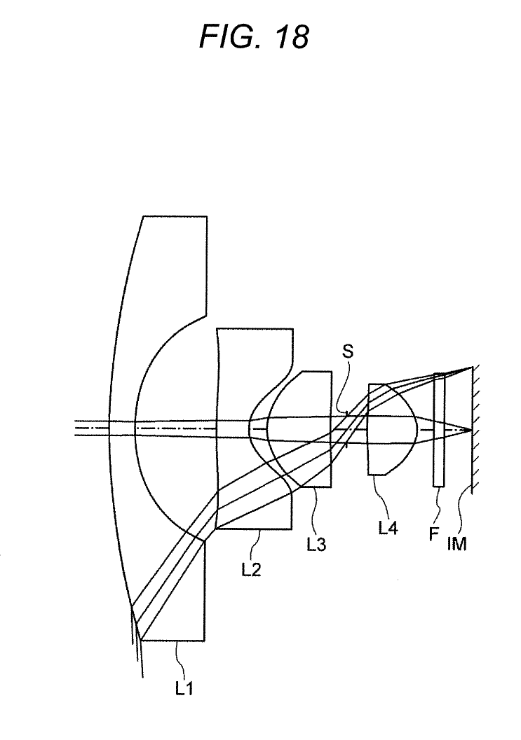

Lens data of Example 6 is shown in Table 6. FIG. 18 is a cross-sectional view of a lens according to Example 6. An imaging lens according to Example 6 includes a first lens L1, a second lens L2, a third lens L3, an aperture stop S, and a fourth lens L4 in order from an object side. The first lens L1 and the second lens L2 have negative refractive power, and the third lens L3 and the fourth lens L4 have positive refractive power. The first lens L1 is formed of a plastic material. An object-side surface of the first lens L1 is formed to have an aspherical shape. A peripheral part of the object-side surface of the first lens L1 has positive refractive power. The first lens L1 has a concave surface facing an image side, the second lens L2 has a concave surface facing the image side, the third lens L3 has a convex surface facing the object side, and the fourth lens L4 has a convex surface facing the image side. F is a parallel plate such as cover glass and an IR cut filter, and IM is an imaging surface of a solid state image sensor.

TABLE 6
[Example 6]
Reference Wave Length = 587.56 nm
unit: mm

| surface | | | | | eff. |
|---|---|---|---|---|---|
| number | r | d | nd | vd | diameter |
| 1* | 20.9758 | 0.8000 | 1.54470 | 56.00 | 12.863 |
| 2* | 5.1309 | 2.4914 | | | 6.881 |
| 3* | 11.7626 | 0.9598 | 1.53048 | 55.72 | 6.060 |
| 4* | 0.9567 | 0.5476 | | | 3.850 |
| 5* | 1.9171 | 1.9410 | 1.63200 | 23.40 | 3.510 |
| 6* | −18.8610 | 0.4800 | | | 2.061 |
| STO | INFINITY | 0.6132 | | | 0.795 |
| 8* | 4.2820 | 1.5334 | 1.53048 | 55.72 | 2.151 |
| 9* | −0.9600 | 0.5241 | | | 2.751 |
| 10 | INFINITY | 0.3000 | 1.56400 | 47.00 | 3.385 |
| 11 | INFINITY | 0.8760 | | | 3.465 |

Surface number: aspherical coefficient
1:
K = 0.00000e+000, A4 = −6.58293e−005, A6 = 1.72741e−006,
A8 = 2.99117e−009, A10 = −4.78507e−010, A12 = 4.90978e−012
2:
K = 0.00000e+000, A4 = 4.41305e−003, A6 = −1.33075e−003,
A8 = 3.10218e−004, A10 = −2.28327e−005, A12 = 5.84599e−007
3:
K = −3.28381e+001, A4 = −6.93633e−003, A6 = 1.13291e−004,
A8 = 5.40339e−005, A10 = −3.41528e−006
4:
K = −1.65423e+000, A4 = 1.16391e−001, A6 = −5.31827e−002,
A8 = 5.74934e−003, A10 = −2.95623e−005
5:
K = 0.00000e+000, A4 = 4.47023e−002, A6 = −1.41596e−002,
A8 = −2.14457e−004, A10 = −3.44528e−004
6:
K = 0.00000e+000, A4 = 8.25610e−002, A6 = −5.50611e−002,
A8 = 4.23568e−002, A10 = −9.91868e−003, A12 = 1.14367e−003
8:
K = 0.00000e+000, A4 = −1.47631e−001, A6 = 1.41497e−001,
A8 = −9.45915e−002, A10 = 2.18300e−002
9:
K = −2.00000e+000, A4 = −8.26021e−002, A6 = −7.67482e−003,
A8 = 1.73154e−002, A10 = −5.97261e−003

| | |
|---|---|
| FL | 0.904 |
| Fno | 2.08 |
| w | 187.00 |
| Ymax | 1.918 |
| BF | 1.582 |
| TL | 10.948 |

| Elem | Surfs Focal | Length | Diameter |
|---|---|---|---|
| 1 | 1-2 | −12.6960 | 12.863 |
| 2 | 3-4 | −2.0254 | 6.060 |
| 3 | 5-6 | 2.8569 | 3.510 |
| 4 | 8-9 | 1.6451 | 2.751 |

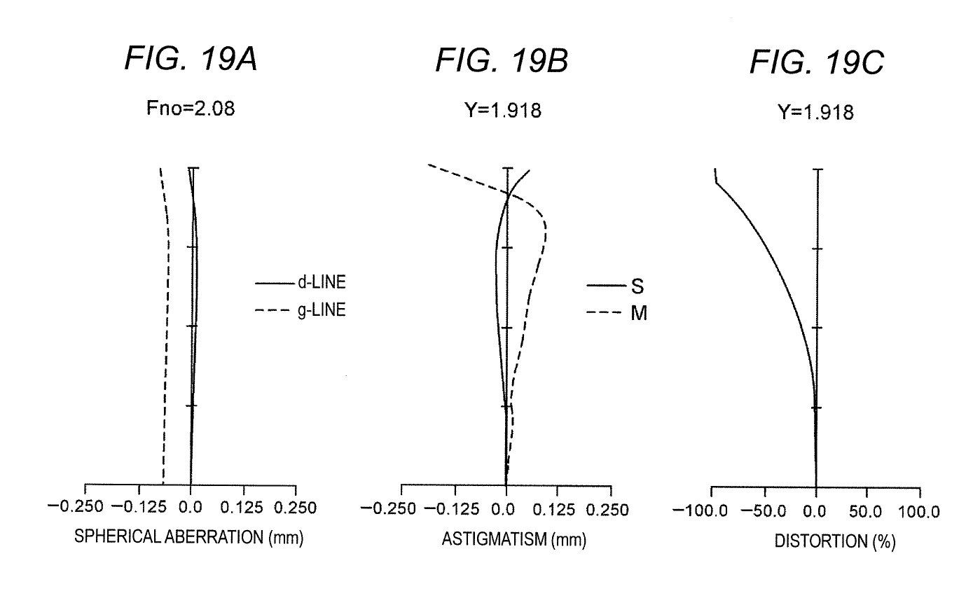

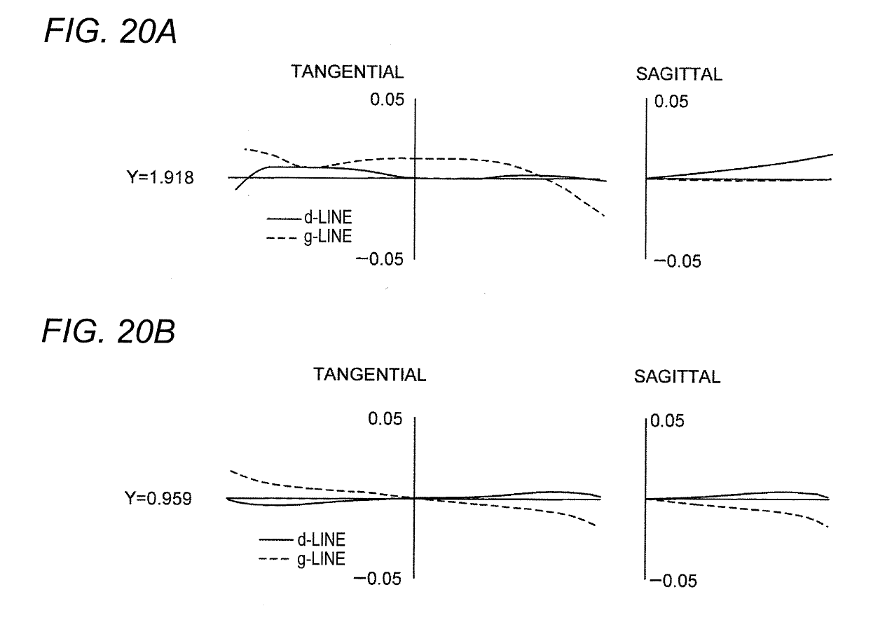

FIG. 19 is aberration diagrams (spherical aberration (a), astigmatism (b), and distortion (c)) of Example 6. FIG. 20 illustrates meridional coma (a) and (b)).

### Example 7

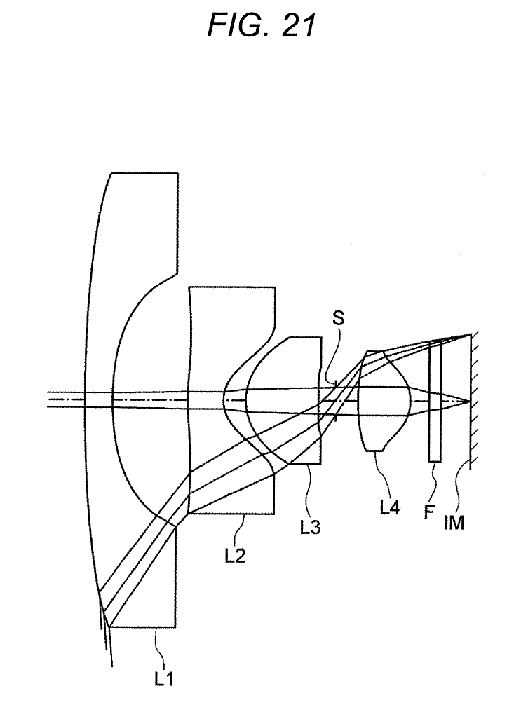

Lens data of Example 7 is shown in Table 7. FIG. 21 is a cross-sectional view of a lens according to Example 7. An imaging lens according to Example 7 includes a first lens L1, a second lens L2, a third lens L3, an aperture stop S, and a fourth lens L4 in order from an object side. The first lens L1 and the second lens L2 have negative refractive power, and the third lens L3 and the fourth lens L4 have positive refractive power. The first lens L1 is formed of a plastic material. An object-side surface of the first lens L1 is formed to have an aspherical shape. A peripheral part of the object-side surface of the first lens L1 has positive refractive power. The first lens L1 has a concave surface facing an image side, the second lens L2 has a concave surface facing the image side, the third lens L3 has a convex surface facing the object side, and the fourth lens L4 has a convex surface facing the image side. F is a parallel plate such as cover glass and an IR cut filter, and IM is an imaging surface of a solid state image sensor.

TABLE 7
[Example 7]
Reference Wave Length = 587.56 nm
unit: mm

| surface | | | | | |
|---|---|---|---|---|---|
| number | r | d | nd | vd | eff. diameter |
| 1* | 99.7730 | 0.8000 | 1.54470 | 56.00 | 12.924 |
| 2* | 8.1687 | 2.1309 | | | 7.190 |
| 3* | 11.6128 | 1.0310 | 1.53048 | 55.72 | 6.500 |
| 4* | 0.9622 | 0.6250 | | | 4.153 |
| 5* | 2.0408 | 2.0683 | 1.63200 | 23.40 | 3.637 |
| 6* | 3617.4634 | 0.4800 | | | 1.968 |
| STO | INFINITY | 0.6382 | | | 0.786 |
| 8* | 3.4476 | 1.5187 | 1.53048 | 55.72 | 2.535 |
| 9* | −0.9722 | 0.5240 | | | 2.808 |
| 10 | INFINITY | 0.3000 | 1.56400 | 47.00 | 3.388 |
| 11 | INFINITY | 0.8760 | | | 3.471 |

Surface number: aspherical coefficient
1:
K = 0.00000e+000, A4 = 3.80379e−004, A6 = 1.22722e−007,
A8 = −4.26696e−008, A10 = −8.43442e−010, A12 = 1.66765e−011
2:
K = 0.00000e+000, A4 = 2.72172e−003, A6 = −2.15756e−004,
A8 = 9.08544e−005, A10 = −7.06194e−006, A12 = 2.16274e−007
3:
K = −5.93299e+000, A4 = −7.53002e−003, A6 = 8.93918e−005,
A8 = 5.52211e−005, A10 = −3.15012e−006
4:
K = −1.86098e+000, A4 = 1.31809e−001, A6 = −5.13977e−002,
A8 = 5.65127e−003, A10 = −1.51596e−004
5:
K = 0.00000e+000, A4 = 4.77225e−002, A6 = −7.14230e−003,
A8 = −8.32799e−004, A10 = −1.23057e−004
6:
K = 0.00000e+000, A4 = 1.07470e−001, A6 = −5.40565e−002,
A8 = 2.92632e−002, A10 = 7.91229e−003, A12 = 1.14367e−003
8:
K = 0.00000e+000, A4 = −9.86947e−002, A6 = 8.79011e−002,
A8 = −3.37835e−002, A10 = 6.32040e−003
9:
K = −2.00000e+000, A4 = −7.03031e−002, A6 = 2.00520e−002,
A8 = −9.35167e−003, A10 = 6.66469e−003

| | |
|---|---|
| FL | 0.905 |
| Fno | 2.08 |
| w | 187.00 |
| Ymax | 1.918 |
| BF | 1.700 |
| TL | 10.993 |

| Elem | Surfs Focal | Length | Diameter |
|---|---|---|---|
| 1 | 1-2 | −16.3845 | 12.924 |
| 2 | 3-4 | −2.0463 | 6.500 |
| 3 | 5-6 | 3.2303 | 3.637 |
| 4 | 8- | 1.6228 | 2.808 |

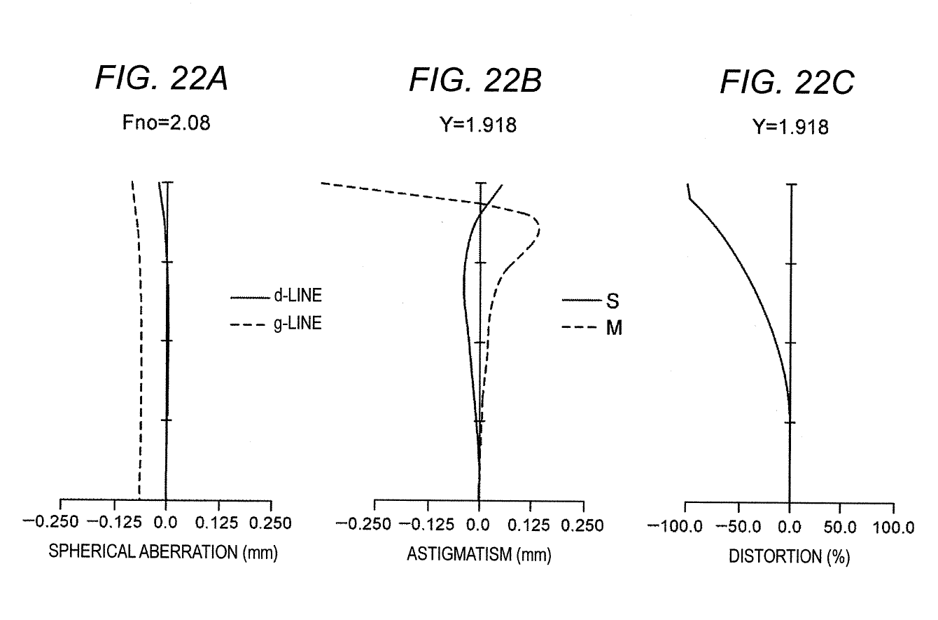

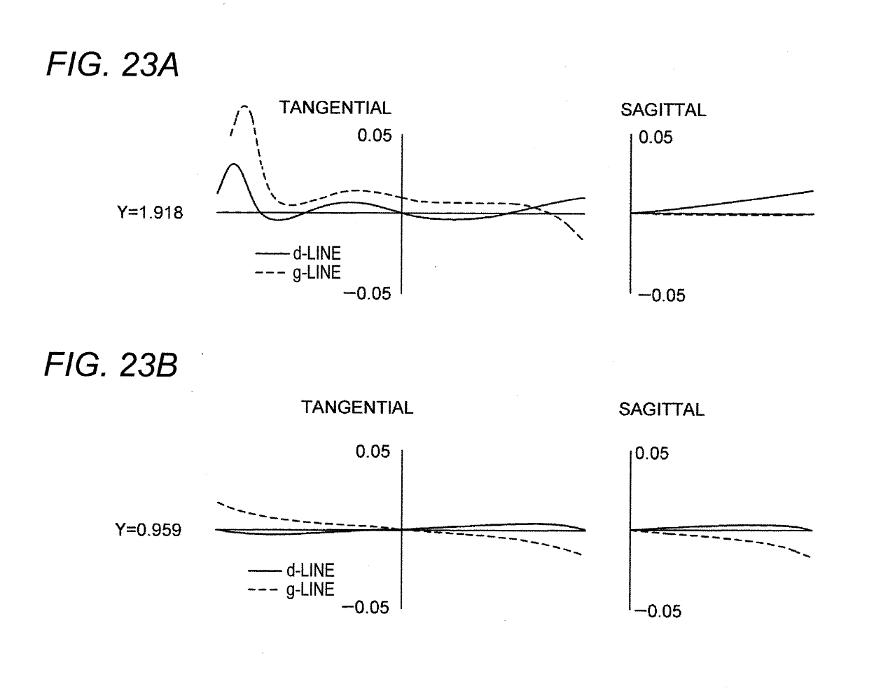

FIG. 22 is aberration diagrams (spherical aberration (a), astigmatism (b), and distortion (c)) of Example 7. FIG. 23 illustrates meridional coma (a) and (b)).

Values of the examples corresponding to each conditional expression are summarized in Table 8.

TABLE 8

| Expression | | Example | Example | Example | Example | Example | Example | Example |
|---|---|---|---|---|---|---|---|---|
| number | Conditional expression | 1 | 2 | 3 | 4 | 5 | 6 | 7 |
| (1) | f2/f | −1.68 | −1.67 | −1.75 | −1.70 | −1.59 | −2.28 | −2.30 |
| (2) | (r1 + r2)/(r1 − r2) | 1.00 | 1.00 | 1.05 | 1.00 | 0.14 | 1.65 | 1.18 |
| (3) | n1 | 56.00 | 56.00 | 56.00 | 56.00 | 56.00 | 56.00 | 56.00 |
| (3) | θ1 | 20.26 | 20.29 | 20.10 | 20.01 | 22.60 | 18.41 | 17.83 |
| (4) | θ2 · 6 | 2.04 | 2.16 | 3.72 | 1.98 | −12.92 | 20.91 | 5.58 |
| (5) | f/r1 | 0.00 | 0.00 | 0.00 | 0.00 | −0.05 | 0.04 | 0.01 |
| (6) | f3/f | 2.27 | 2.20 | 2.53 | 2.26 | 2.31 | 3.16 | 3.57 |
| (7) | f1/f | −8.93 | −7.19 | −9.27 | −8.55 | −15.89 | −14.04 | −18.11 |
| (8) | f34/f | 2.87 | 2.63 | 2.98 | 2.97 | 2.22 | 3.76 | 3.65 |
| (9) | (r5 + r6)/(r5 − r6) | −0.44 | −0.62 | −0.76 | −0.35 | −0.73 | −0.82 | −1.00 |
| (10) | f3/f4 | 1.17 | 1.11 | 1.35 | 1.08 | 1.48 | 1.74 | 1.99 |

The present invention is not limited to the embodiments and examples described in the present specification. It is obvious for a person skilled in the art that the present invention also includes other examples and modification, based on the embodiments, examples, and technical ideas described in the present specification. For example, a dummy lens having substantially no refractive power may be further added to the present invention within an application range of the present invention.

### REFERENCE SIGNS LIST

1 imaging device
2 cable
L1 first lens
L2 second lens
L3 third lens
L4 fourth lens
LN imaging lens
IM image sensor

1. An imaging lens comprising, in order from an object side:
a first lens having negative refractive power;
a second lens having negative refractive power;
a third lens; and
a fourth lens,
wherein an object-side surface of the first lens is formed to have an aspherical shape, and the imaging lens satisfies the following conditional expressions:
−2.8<f2/f<−0.5 (1)
0.0<(r1+r2)/(r1−r2)<2.3 (2)
where
f2 represents a focal length (mm) of the second lens,
f represents a focal length (mm) of an entire system,
r1 represents a radius of curvature (mm) of the object-side surface of the first lens, and
r2 represents a radius of curvature (mm) of an image-side surface of the first lens.

2. The imaging lens according to claim 1, wherein the third lens and the fourth lens have positive refractive power.

3. The imaging lens according to claim 1, wherein a peripheral part of the object-side surface of the first lens has positive refractive power.

4. The imaging lens according to claim 1, wherein the first lens has a concave surface facing an image side, the second lens has a concave surface facing the image side, the third lens has a convex surface facing the object side, and the fourth lens has a convex surface facing the image side.

5. The imaging lens according to claim 1, wherein a material of the first lens satisfies the following conditional expression:
40<v1<70 (3)
where
v1 represents an Abbe number of the first lens.

6. The imaging lens according to claim 1, wherein the first lens is formed of a plastic material.

7. The imaging lens according to claim 1, comprising an aperture stop between the third lens and the fourth lens.

8. The imaging lens according to claim 1, wherein, assuming that a maximum plane angle between the object-side surface of the first lens and a line perpendicular to an optical axis is θ1 (°), a distance between the optical axis and a position of θ1 is h1, and a plane angle between the object-side surface and a line perpendicular to the optical axis intersecting at a position of a distance h1/5 from the optical axis is θ2 (°), the following conditional expression is satisfied:
θ1>θ2·6 (4).

9. The imaging lens according to claim 1, wherein the imaging lens satisfies the following conditional expression:
−0.06<f/r1<0.06 (5).

10. The imaging lens according to claim 1, wherein the imaging lens satisfies the following conditional expression:
1.8<f3/f<4.3 (6)
where
f3 represents a focal length (mm) of the third lens.

11. The imaging lens according to claim 1, wherein the imaging lens satisfies the following conditional expression:
−30.0<f1/f<−6.0 (7)
where
f1 represents a focal length (mm) of the first lens.

12. The imaging lens according to claim 1, wherein the imaging lens satisfies the following conditional expression:
2.0<f34/f<4.0 (8)
where
f34 represents a composite focal length (mm) of the third lens and the fourth lens.

13. The imaging lens according to claim 1, wherein the imaging lens satisfies the following conditional expression:
−1.0≦(r5+r6)/(r5−r6)<−0.2 (9)
where
r5 represents a radius of curvature (mm) of the object-side surface of the third lens, and
r6 represents a radius of curvature (mm) of an image-side surface of the third lens.

14. The imaging lens according to claim 1, wherein the imaging lens satisfies the following conditional expression:
0.8<f3/f4<2.0 (10)
where
f3 represents a focal length (mm) of the third lens, and
f4 represents a focal length (mm) of the fourth lens.

15. The imaging lens according to claim 1, wherein the image-side surface of the second lens is an aspherical surface.

16. The imaging lens according to claim 1, comprising a lens having substantially no refractive power.

17. An imaging device comprising the imaging lens according to claim 1.

18. The imaging lens according to claim 2, wherein a peripheral part of the object-side surface of the first lens has positive refractive power.

19. The imaging lens according to claim 2, wherein the first lens has a concave surface facing an image side, the second lens has a concave surface facing the image side, the third lens has a convex surface facing the object side, and the fourth lens has a convex surface facing the image side.

20. The imaging lens according to claim 2, wherein a material of the first lens satisfies the following conditional expression:
40<v1<70 (3)
where
v1 represents an Abbe number of the first lens.
